(19) United States
(12) Patent Application Publication
(10) Pub. No.: US 2010/0025412 A1
(43) Pub. Date: Feb. 4, 2010

(54) PART MANUFACTURING METHOD, PART, AND TANK

(76) Inventor: Yoshitaka Wakao, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/518,487

(22) PCT Filed: Dec. 5, 2007
(86) PCT No.: PCT/IB07/03763

§ 371 Date: Jul. 27, 2009

(30) Foreign Application Priority Data
Dec. 11, 2006 (JP) 2006-333018

(51) Int. Cl. F17C 1/06; B65H 81/02

(52) U.S. Cl. 220/590; 156/172

(57) ABSTRACT

A method for manufacturing a part having a resin-impregnated fiber layer (4) formed by hardening resin-impregnated fiber has a forming procedure for forming the resin-impregnated fiber layer (4). The forming procedure includes a winding process for winding a predetermined amount of the resin-impregnated fiber and a gelling process for gelling the resin in the wound portion of the resin-impregnated fiber. In the forming procedure, the winding process is performed again after the winding process and the gelling process are performed, whereby a predetermined amount of the resin-impregnated fiber is wound on the gelled resin-impregnated fiber.

### BACKGROUND OF THE INVENTION

1. Field of the Invention

The invention relates to a manufacturing method for manufacturing a part, such as a tank and a pipe, and to a part and a tank. More particularly, the invention relates to a manufacturing method for manufacturing a part having a resin-impregnated fiber layer formed by hardening resin-impregnated fiber, and to a part and a tank each having such a resin-impregnated fiber.

2. Description of the Related Art

In recent years, developments of high-pressure hydrogen tanks for fuel cell systems have been progressing. Typically, high-pressure hydrogen tanks for fuel cell systems are manufactured using the filament-winding method (will be referred to as “FW method”). More specifically, using the FW method, a resin-impregnated fiber is wound around a liner, and then the resin in the resin-impregnated fiber is hardened, whereby a resin-impregnated fiber layer is formed which covers the outer face of the liner. The resin-impregnated fiber layer thus formed provides the high-pressure hydrogen tank with a sufficient strength. The resin-impregnated fiber layer is made of, for example, a CFRP (Carbon Fiber Reinforced Plastics).

In the meantime, when winding such a resin-impregnated fiber around a liner, the resin-impregnated fiber comes to have some tension, and this tension causes a tightening effect. Because of this tightening effect, as the resin-impregnated fiber continues to be wound around the liner, that is, as the thickness of the resin-impregnated fiber layer increases, the impregnated resin seeps out (flows out) of the resin-impregnated fiber layer, and the amount of the seeping resin tends to be larger in the inner side of the resin-impregnated fiber layer.

A method for preventing such seepage of resin is described in Japanese Patent Application Publication No. 09-30869 (JP-A-09-30869). The method is a method for manufacturing a tank. In this manufacturing method, a resin-impregnated fiber is wound around a mandrel (wound object) to a predetermined thickness, and then it is heated so that the solvent of resin in the resin-impregnated fiber is removed. These processes are repeated until the resin is hardened.

This manufacturing method, however, is to remove the solvent, and therefore the hardening degree of the resin, such as the reaction rate/viscosity of resin, is unknown. Therefore, when the resin is soft, there is a possibility of seepage of resin, and when the resin is hard, there is a possibility of layer separations.

### SUMMARY OF THE INVENTION

The invention provides a part manufacturing method, a part, and a tank that suppress the seepage of resin from a resin-impregnated fiber due to the winding of the same fiber, while preventing separations within the resin-impregnated fiber layer.

To achieve this object, the first aspect of the invention relates to a method for manufacturing a part having a resin-impregnated fiber layer formed by hardening a resin-impregnated fiber, the method having a forming procedure for forming the resin-impregnated fiber layer, which includes a winding process for winding a predetermined amount of the resin-impregnated fiber and a gelling process for gelling the resin in the wound portion of the resin-impregnated fiber. In the forming procedure, the winding process is performed again after the winding process and the gelling process have been performed.

According to this manufacturing method, the gelling process suppresses the movement of the resin in the wound portion of the resin-impregnated fiber. Thus, in the forming procedure, when winding the next portion of the resin-impregnated fiber, it is placed on the already-wound portion of the resin-impregnated fiber that has been gelled by the gelling process. Thus, when winding the next portion of the resin-impregnated fiber, the seepage of the resin in the wound portion of the resin-impregnated fiber can be suppressed. Further, because the next portion of the resin-impregnated fiber is wound after gelling the wound portion of the resin-impregnated fiber, the possibility that a separation occurs between the mating faces of the portions of the resin-impregnated fiber that are stacked on top of each other is very low.

The manufacturing method according to the first aspect of the invention may be such that in the forming procedure, the winding process and the gelling process are alternately repeated multiple times.

In this case, the resin-impregnated fiber layer can be formed to have a desired thickness while preventing separations within the resin-impregnated fiber layer. Further, because the seepage of resin can be suppressed even if the resin-impregnated fiber is wound multiple times, the fiber density in the resin-impregnated fiber layer can be finely adjusted when forming the same layer.

Further, the manufacturing method according to the first aspect of the invention may be such that the gelling process is accomplished by implementing one of a room-temperature exposing method in which the wound portion of the resin-impregnated fiber is exposed to a room temperature, a constant-temperature bath heating method in which the wound portion of the resin-impregnated fiber is heated in a constant-temperature bath, and a heater heating method in which the wound portion of the resin-impregnated fiber is heated using a heater.

Further, the manufacturing method according to the first aspect of the invention may be such that the forming procedure includes a hardening process for hardening the resin in the resin-impregnated fiber.

In this case, because the resin is hardened during the forming procedure, for example, even when the resin-impregnated fiber layer has been made very large, the resin-impregnated fiber layer can be made stable.

Further, the manufacturing method according to the first aspect of the invention may be such that the hardening process is performed in a final step of the forming procedure.

In this case, a resin-impregnated fiber layer can be formed by hardening both the gel-state resin in the resin-impregnated fiber and the resin in the resin-impregnated fiber wound thereon.

Further, the manufacturing method according to the first aspect of the invention may be such that the forming procedure includes another hardening process for hardening the resin in the resin-impregnated fiber, which is performed in an intermediate step of the forming procedure.

Further, the manufacturing method according to the first aspect of the invention may be such the resin in the resin-impregnated fiber is a thermosetting resin and the gelling process is accomplished by heating the resin in the wound portion of the resin-impregnated fiber at a temperature lower than the temperature at which the resin in the wound portion of the resin-impregnated fiber is heated in the hardening process.

In this case, because the resin is not completely hardened in the gelling process, the resin can be properly gelled. Further, because the gelling of the resin is accomplished by heating the resin, the resin can be gelled in a short time. Further, because a common heating device can be used for the gelling process and the hardening process, the production equipment can be made compact.

Further, the manufacturing method according to the first aspect of the invention may be such that the resin in the resin-impregnated fiber is a thermosetting resin, the gelling process is performed at a room temperature, and the hardening process is performed at a temperature higher than the room temperature.

In this case, the gelling process can be accomplished in a simple manner.

Further, the manufacturing method according to the first aspect of the invention may be such that the resin gelled by the gelling process has a viscosity of 6000 to 12000 mPa·s.

Further, the manufacturing method according to the first aspect of the invention may be such that the resin gelled by the gelling process has a viscosity of 9000 mPa·s.

Further, the manufacturing method according to the first aspect of the invention may be such that the resin gelled by the gelling process has a hardening reaction rate of approximately 35%.

Further, the manufacturing method according to the first aspect of the invention may be such that the winding process is accomplished by implementing a filament-winding method in which a fiber is impregnated with resin and a predetermined amount of the obtained resin-impregnated fiber is then wound.

In this case, the strength of the resin-impregnated fiber layer can be further increased.

Further, the manufacturing method according to the first aspect of the invention may be such that: the winding process is such that a predetermined amount of the resin-impregnated fiber is wound around an wound object while rotating the wound object, and the gelling process is such that the resin in the portion of the resin-impregnated fiber which is wound around the wound object is gelled while rotating the wound object.

This method minimizes the possibility that the resin be concentrated on a specific portion of the wound object as a result of the gelling process. Therefore, the thickness of the resin-impregnated fiber layer can be adjusted properly. Further, because a common device can be used for rotating the wound object in the winding process and the gelling process, the production equipment can be made compact.

The “wound object” may either be an object that forms a portion of the manufactured part or an object that is removed after finishing the forming procedure and thus does not form any portion of the manufactured part. In the former case, assuming that the part is a tank, the wound object may be a hollow liner of the tank.

Further, the manufacturing method according to the first aspect of the invention may be such that the resin in the resin-impregnated fiber is an epoxy resin.

The second aspect of the invention relates to a tank manufactured in the manufacturing method according to the first aspect of the invention. This tank has a liner layer covered by the resin-impregnated fiber layer.

According to this structure, the tank can be reinforced by the resin-impregnated fiber layer.

Further, in order to achieve the foregoing object, the third aspect of the invention relates to a part having a resin-impregnated fiber layer formed through winding and hardening of a resin-impregnated fiber, wherein the resin-impregnated fiber layer includes a first portion having a first fiber volume content and a second portion located further to the radially outer side of the part than the first portion and having a second fiber volume content that is larger than the first fiber volume content.

The part according to the third aspect of the invention may be a tank having a liner layer covered by the resin-impregnated fiber.

As such, the part manufacturing method, part, and tank according to the invention suppress. the seepage of resin from the resin-impregnated fiber when it is wound, while preventing separations within the resin-impregnated fiber layer.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a view showing a fuel cell car having a high-pressure tank according to the first example embodiment of the invention;

FIG. 2 is a view illustrating the method for manufacturing the high-pressure tank according to the first example embodiment of the invention, in which a portion of the high-pressure tank is cut away;

FIG. 3A is a side view of the liner which illustrates the hoop-pattern winding method employed in the invention to wind a resin-impregnated fiber;

FIG. 3B is a side view of the liner which illustrates the helical-pattern winding method employed in the invention to wind a resin-impregnated fiber;

FIG. 4 is a flowchart illustrating the forming procedure for forming a resin-impregnated-fiber layer of the first example embodiment of the invention;

FIG. 5 is a perspective view illustrating an example of the gelling process of the first example embodiment of the invention, in which the liner is put in a constant-temperature bath;

FIG. 6 is a perspective view illustrating another example of the gelling process of the first example embodiment of the invention, in which the liner is set beside an electric heater;

FIG. 7 is a cross-sectional view of the high-pressure tank that has been manufactured through the forming procedure of the first example embodiment of the invention, showing an enlarged cross-section of the portion indicated by the circle VII in FIG. 2;

FIG. 8 is a cross-sectional view showing an enlarged cross-section of the portion indicated by the circle VIII in FIG. 7;

FIG. 9 is a graph indicating the fiber volume content V_{f} at each layer position in the resin-impregnated-fiber layer; and

FIG. 10 is a flowchart illustrating the forming procedure for forming a resin-impregnated-fiber layer of the second example embodiment of the invention.

### DETAILED DESCRIPTION OF THE EMBODIMENTS

Hereinafter, parts according to example embodiments of the invention will be described with reference to the accompanying drawings. The following example embodiments recite a high-pressure tank as a part.

### First Example Embodiment

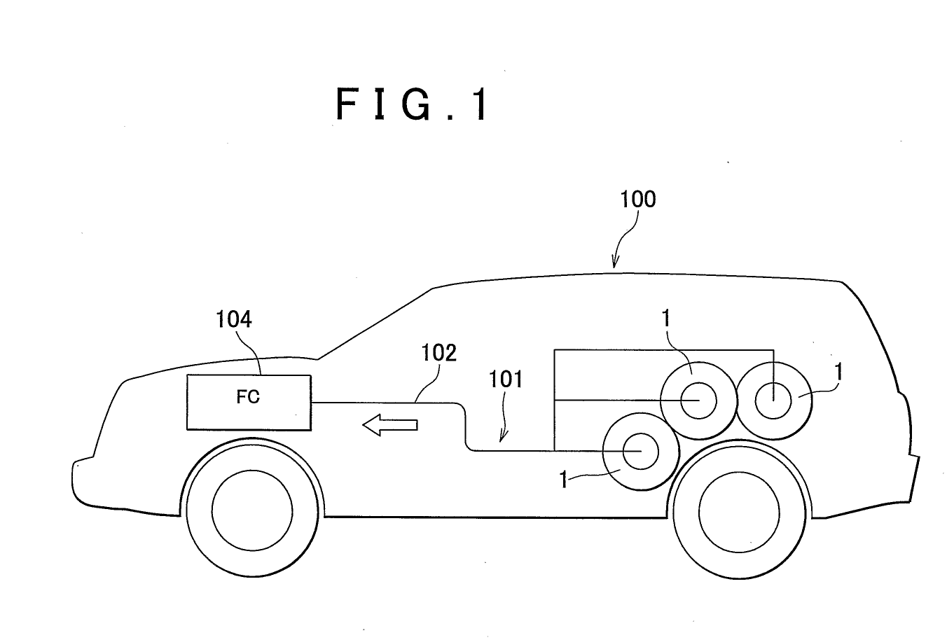

FIG. 1 is a view schematically showing a fuel cell car 100 having high-pressure tanks according to the first example embodiment of the invention. The fuel cell car 100 has, for example, three high-pressure tanks 1 in the rear portion of the vehicle body. Each high-pressure tank 1 is a component of a fuel cell system 101 and is arranged to supply fuel gas to a fuel cell unit 104 via a gas supply line 102. The fuel gas stored in each high-pressure tank 1 is a combustible high-pressure gas, such as a compressed natural gas or a hydrogen gas. Note that the high-pressure tanks 1 can be used in various other types of automotives (e.g., electric cars, hybrid cars), various other types of vehicles (e.g., ships, boats, airplanes, robots), or various stationary systems or units, as well as in fuel cell cars.

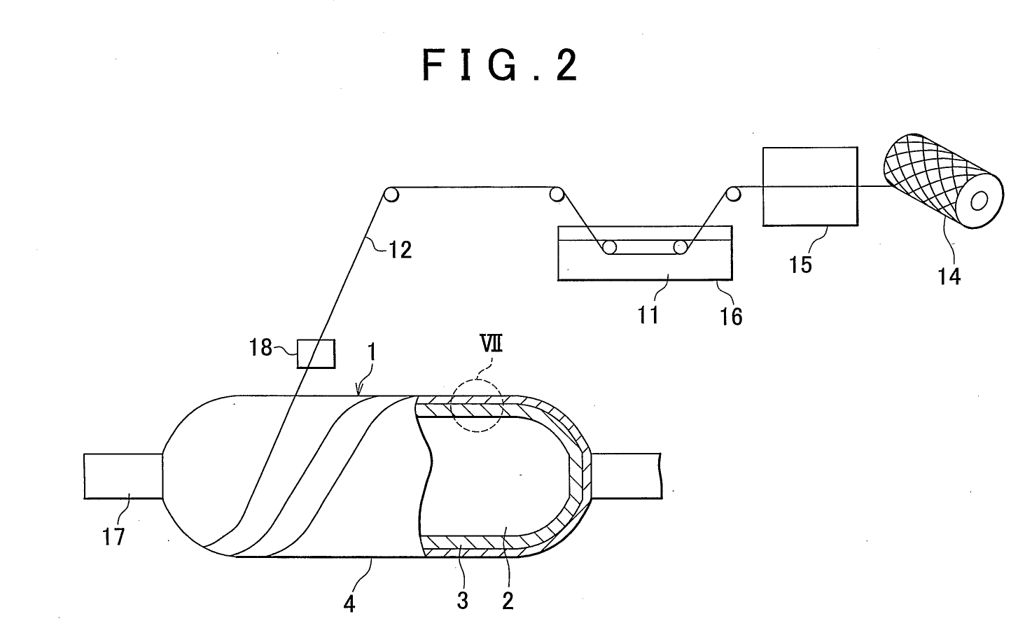

FIG. 2 is a view for explaining a high-pressure tank manufacturing method according to the first example embodiment of the invention, in which a portion of the high-pressure tank 1 is cut away. The high-pressure tank 1 is constituted of a liner 3 that is formed in a hollow shape having a storage space 2 therein and a resin-impregnated-fiber layer 4 consisting of multiple layers and covering the outer face of the liner 3. The high-pressure tank 1 supplies fuel gas into the gas supply line 102 via an opening formed at the center of one axial end of the high-pressure tank 1 (not shown in the drawing) or via two openings each formed at the center of each axial end of the high-pressure tank 1 (not shown in the drawings).

The storage space 2 is formed to store fluid or fuel gas at an atmospheric pressure or higher (that is, at a high pressure). For example, hydrogen gas is stored at 35 MPa or 70 MPa in each high-pressure tank 1. In the following, an example will be described in which hydrogen gas is stored in each high-pressure tank 1 as high-pressure gas.

The liner 3 can be said to be an “inner shell” or “inner container” of the high-pressure tank 1. The liner 3 serves as a gas barrier to block the permeation of the hydrogen gas to the outside. The material of the liner 3 may be selected from among various materials including metal and hard resin (e.g., polyethylene resin, polypropylene resin). The outer face of the liner 3 is covered by the resin-impregnated-fiber layer 4.

The resin-impregnated-fiber layer 4 can be said to be an “outer shell” or “outer container” of the high-pressure tank 1 and serves to reinforce the high-pressure tank 1. The resin-impregnated-fiber layer 4 is formed by winding a resin-impregnated fiber around the liner 3 and hardening it. The resin-impregnated fiber is a fiber 12 impregnated with matrix resin 11 (will be simply referred to as “resin 11”).

Examples of the resin 11 include epoxy resin, denatured epoxy resin, unsaturated polyester resin, etc. In this example embodiment, the resin 11 is epoxy resin.

Examples of the fiber 12 include inorganic fibers (e.g., metal fiber, glass fiber, carbon fiber, alumina fiber), synthetic organic fibers (e.g., aramid fiber), and natural organic fibers (e.g., cotton). The fiber 12 may either be one of these fibers or a mixed fiber obtained by mixing two or more of them. Among these fibers, for example, carbon fiber or aramid fiber may be used. In the first example embodiment, the fiber 12 is a carbon fiber. That is, the resin-impregnated-fiber layer 4 of the first example embodiment is a CFRP (Carbon Fiber Reinforced Plastic) obtained by reinforcing the resin 11 by the fiber 12, rather than by using a solvent.

Preferably, the content ratio between the resin 11 and the fiber 12 is 10-80% by volume: 90-20% by volume (more preferably, 25-50% by volume: 75-50% by volume), although it depends upon the types of the resin and finer used, the fiber reinforcement direction, the thickness, and so on. In addition to these materials, the resin-impregnated-fiber layer 4 may contain necessary additive or additives if any.

The fiber 12 is unreeled from a bobbin 14, and the tension of the fiber 12 is adjusted by a tension adjustor 15. The fiber 12 is then soaked in a resin tank 16, whereby the liquid resin 11 is impregnated into the fiber 12, whereby a resin-impregnated fiber is obtained. The obtained resin-impregnated fiber is then wound around the liner 3 at a given tension. More specifically, at this time, the liner 3 is first put on a shaft 17, and the liner 3 is rotated together with the shaft 17. Then, the resin-impregnated fiber is sent from a supply unit 18 to the rotating liner 3, whereby the resin-impregnated fiber is wound around the liner 3.

The method for winding the resin-impregnated fiber may be selected from among various methods including the filament-winding method, the hand lay-up method, and the tape-winding method. In the first example embodiment, the resin-impregnated fiber is wound around the liner 3 in hoop and helical patterns using the filament-winding method.

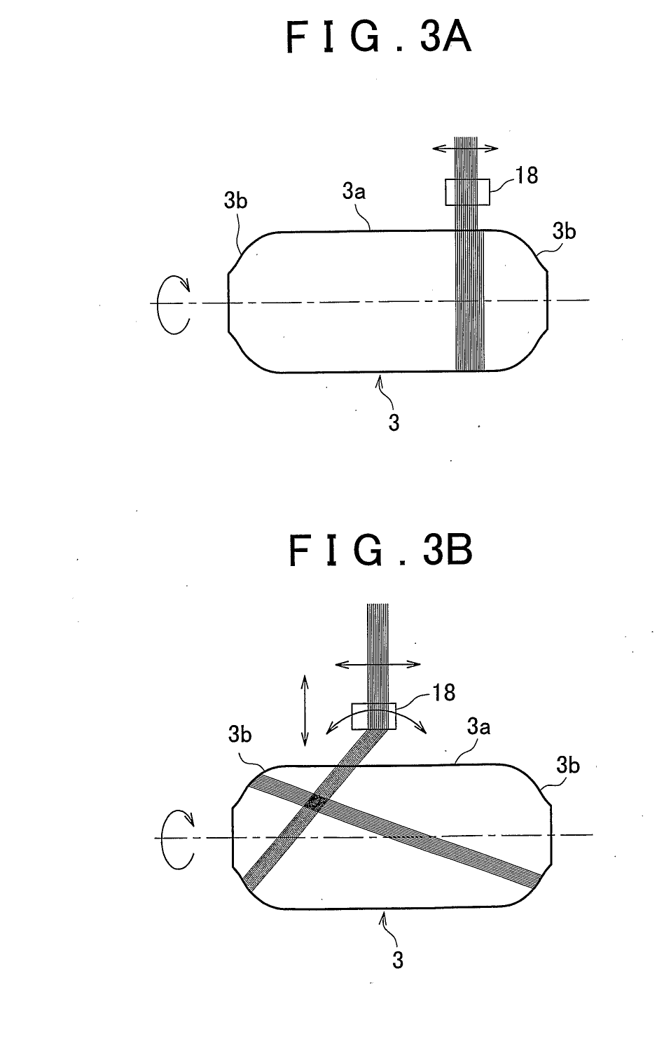

FIG. 3A and FIG. 3B are side views of the liner 3 illustrating how the resin-impregnated fiber is wound around the liner 3 in the first example embodiment. More specifically, FIG. 3A illustrates the hoop-pattern winding method and FIG. 3B illustrates the helical-pattern winding method. Note that, in FIG. 3A and FIG. 3B, the resin-impregnated fiber is indicated as multiple fiber bundles.

Referring to FIG. 3A, in the hoop-pattern winding method, the resin-impregnated fiber is wound around a body 3a of the liner 3 in the circumferential direction. For example, the hoop-pattern winding method is implemented by supplying the resin-impregnated fiber from the supply unit 18 to the liner 3 while rotating the liner 3 and reciprocating the supply unit 18 in the axial direction of the liner 3. Implementing the hoop-pattern winding method forms hoop layers that provide a sufficient strength in the circumferential direction of the body 3a of the liner 3.

On the other hand, referring to FIG. 3B, in the helical-pattern winding method, the resin-impregnated fiber is wound around the body 3a and dome portions 3b of the liner 3 in a helical pattern. This helical-pattern winding method is implemented by, for example, supplying the resin-impregnated fiber from the supply unit 18 to the liner 3 while rotating the liner 3 and reciprocating the supply unit 18 in the axial direction and the radial direction of the liner 3. Implementing the helical-pattern winding method forms helical layers that provide a sufficient strength in the longitudinal direction of the high-pressure tank 1.

In the first example embodiment, the resin-impregnated-fiber layer 4 is formed by repeatedly performing the hoop-pattern winding method and the helical-pattern winding method multiple times. Thus, the resin-impregnated-fiber layer 4 consists of multiple layers. The number of the layers constituting the resin-impregnated-fiber layer 4 is arbitral. For example, it is 10 or 30. The order of performing the hoop-pattern winding method and the helical-pattern winding method is also arbitral and thus may be changed according to design requirements. In the following description, the phrase “winding the resin-impregnated fiber” represents winding the resin-impregnated fiber using both the hoop-pattern winding method and the helical-pattern winding method or using one of them unless otherwise specified.

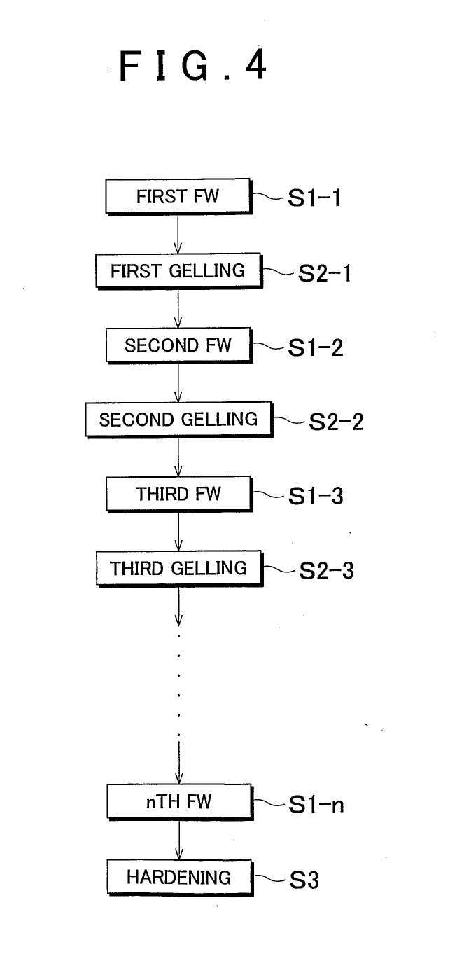

FIG. 4 is a flowchart illustrating the forming procedure for forming the resin-impregnated-fiber layer 4 of the first example embodiment of the invention. This forming procedure includes a winding process for winding a predetermined amount of the resin-impregnated fiber (will be referred to also as “FW process (Filament Winding process)”), a gelling process for gelling the resin in the wound portion of the resin-impregnated fiber, and a hardening process for hardening the resin in the resin-impregnated fiber. With regard to the FW process, the phrase “winding a predetermined amount of the resin-impregnated fiber” represents winding the resin-impregnated fiber more than one time, and thus it includes winding the resin-impregnated fiber several times so that several layers are formed.

First, the first FW process is performed. In this process, a predetermined amount of a resin-impregnated fiber bundle is wound around the liner 3, which is a “wound object”, whereby a first FW layer is formed (S1-1). At this time, the resin 11 in the resin-impregnated fiber of the first FW layer is still in a liquid state. In the first FW process, the resin-impregnated fiber bundle is wound one to five times, for example.

Then, the first gelling process is performed. In this process, the resin 11 in the first FW layer is gelled (S2-1).

The gelling process is accomplished by implementing, for example, a “room-temperature exposing method”, a “constant-temperature bath heating method”, and a “heater heating method”, which will be described in detail below.

First, in the room-temperature exposing method, the liner 3 with the first FW layer formed thereon is exposed to a room temperature for a predetermined period of time. At this time, preferably, the liner 3 is rotated together with the shaft 17 such that the resin 11 is not gelled unevenly. According to this room-temperature exposing method, as such, the resin 11 can be gelled in a simple manner.

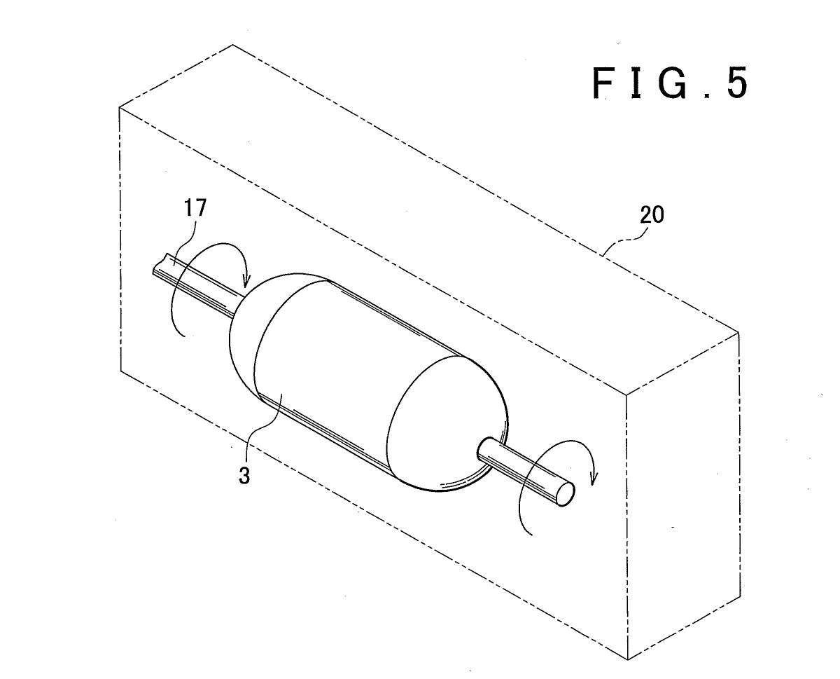

Second, in the constant-temperature bath heating method, referring to FIG. 5, the liner 3 with the first FW layer formed thereon is put in a constant-temperature bath 20 and the atmosphere in the constant-temperature bath 20 is heated. The heating temperature and the heating time for this method are set differently depending upon the property of the resin 11. For example, the heating temperature is set to 60 to 100° C. and the heating time is set to 0.5 to 3.0 hours. When implementing this constant-temperature bath heating method, as in the case of the room-temperature exposing method, preferably, the liner 3 is rotated together with the shaft 17 such that the resin 11 is not gelled unevenly. According to the constant-temperature bath heating method, as such, the gelling process is not influenced by the ambient temperature and therefore the time of the gelling process is short as compared to when the room-temperature exposing method is implemented.

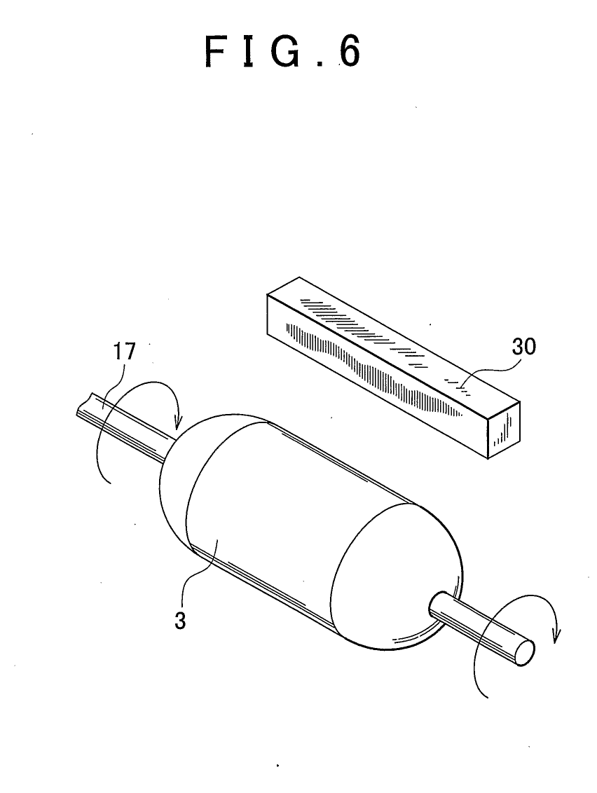

Third, in the heater heating method, referring to FIG. 6, for example, an electric heater 30 is set near the liner 3 with the first FW layer formed thereon, and the electric heater 30 is then turned on. The heating temperature and the heating time for this method are set in the same manner as those for the constant-temperature bath heating method are. When implementing the heater heating method, as in the case of the room-temperature exposing method and the constant-temperature bath heating method, preferably, the liner 3 is rotated together with the shaft 17 such that the resin 11 is not gelled unevenly. According to the heater heating method, as such, the time of the gelling process is short. Further, the heater heating method can be implemented by simply setting the electric heater 30 at the winding equipment, and therefore the equipment cost is smaller than when the constant-temperature bath heating method is implemented.

After gelled in the gelling process described above, the resin 11 has a viscosity of 6000 to 12000 mPa·s. For example, the gelled resin 11 has a viscosity of approximately 9000 mPa·s. Further, the gelled resin 11 may have a reaction rate (hardening rate) of approximately 35%.

Next, the second FW process is performed. In this process, a predetermined amount of the resin-impregnated fiber bundle is wound around the first FW layer (S1-2), which has been gelled as described above, whereby a second FW layer is formed on the first FW layer. At this time, the resin 11 in the resin-impregnated fiber of the second FW layer is still in a liquid state. In the second FW process, the resin-impregnated fiber bundle is wound one to five times, for example.

Then, the second gelling process is performed to gel the resin 11 in the second FW layer (S2-2). As in the case of the first gelling process, the second gelling process is accomplished by implementing, for example, the room-temperature exposing method, the constant-temperature bath heating method, or the heater heating method. Also, the viscosity and the reaction rate of the gelled resin 11 are the same as mentioned above.

Thereafter, if necessary, the third FW process (S1-3) and the third gelling process (S2-3) are performed. That is, the FW process and the gelling process are repeated until a desired thickness of the outer layer of the liner 3 is obtained. After performing the FW process n times, the hardening process (S3), not the gelling process, is performed as the final step of the forming procedure. Note that “n” is a natural number and it is 4 or more in the first example embodiment.

The hardening process is performed at a temperature higher than the gelling process. Specifically, in the hardening process, the resin 11 in each FW layer is heated at, for example, 110 to 150° C. that is higher than the temperature of the gelling process (60 to 100° C.). As such, the gel state resin 11 in each FW layer and the liquid state resin 11 in the n-th FW layer are completely hardened, whereby the resin-impregnated-fiber layer 4 having a desired thickness is formed.

The thickness of the resin-impregnated-fiber layer 4 is not limited to any specific value, and it is normally set in accordance with the material used, the dimensions and shape of the high-pressure tank 1, the required pressure resistance, and so on. For example, the thickness of the resin-impregnated-fiber layer 4 is set to several mm or set within the range of several mm to 50 mm. For example, when the outer diameter of the high-pressure tank 1 is approximately 300 mmΦ, the thickness of the resin-impregnated-fiber layer 4 is typically set to approximately 20 mm.

Meanwhile, the hardening process may be implemented using the same heating device or equipment as that for the gelling process. By doing so, the production equipment can be made compact. For example, the hardening process may be implemented by heating the liner 3 by the constant-temperature bath heating method illustrated in FIG. 5 while rotating the liner 3 about its axis.

As another example, the number of repeating the FW process and the gelling process may be one or two. In the case where the FW process and the gelling process are performed only one time in combination, the forming procedure for forming the resin-impregnated-fiber layer 4 is implemented by performing the first FW process, the gelling process, the second FW process, and the hardening process in this order. In this case, the amount of the resin-impregnated fiber wound in the second FW process may be larger than the amount of the resin-impregnated fiber wound in the first FW process.

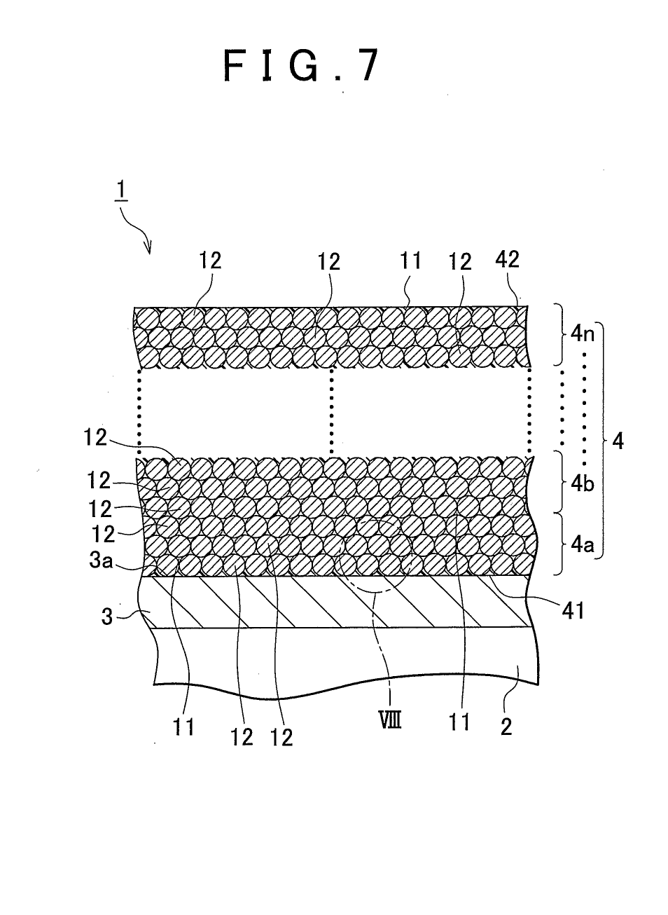

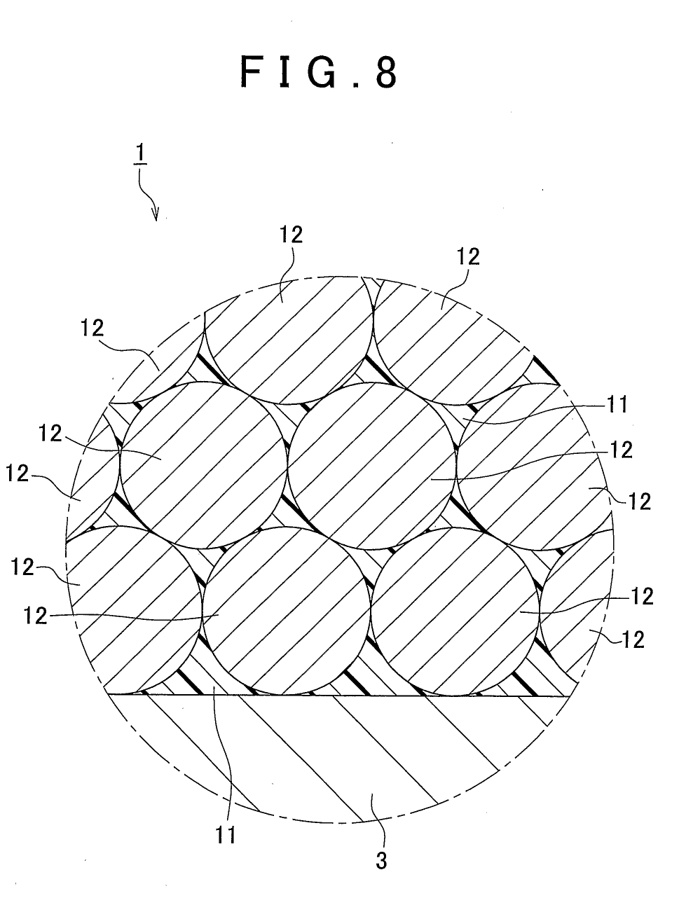

FIG. 7 is a cross-sectional view of the high-pressure tank 1 that has been manufactured through the forming procedure in which the FW processes was performed n times. FIG. 7 shows an enlarged cross-section of the portion indicated by the circle VII in FIG. 2. FIG. 8 shows an enlarged cross-section of the portion indicated by the circle VIII in FIG. 7.

Referring to FIG. 7 and FIG. 8, the resin-impregnated-fiber layer 4 is formed with a predetermined thickness on the outer face of the liner 3 (the body 3a). The resin-impregnated-fiber layer 4 is constituted of the first FW layer 4a formed in the first FW process, the second FW layer 4b formed in the second FW process, and so on up to the n-th FW layer 4n formed in the n-th FW process, which are stacked in this order from an inner face 41 to an outer face 42 of the resin-impregnated-fiber layer 4.

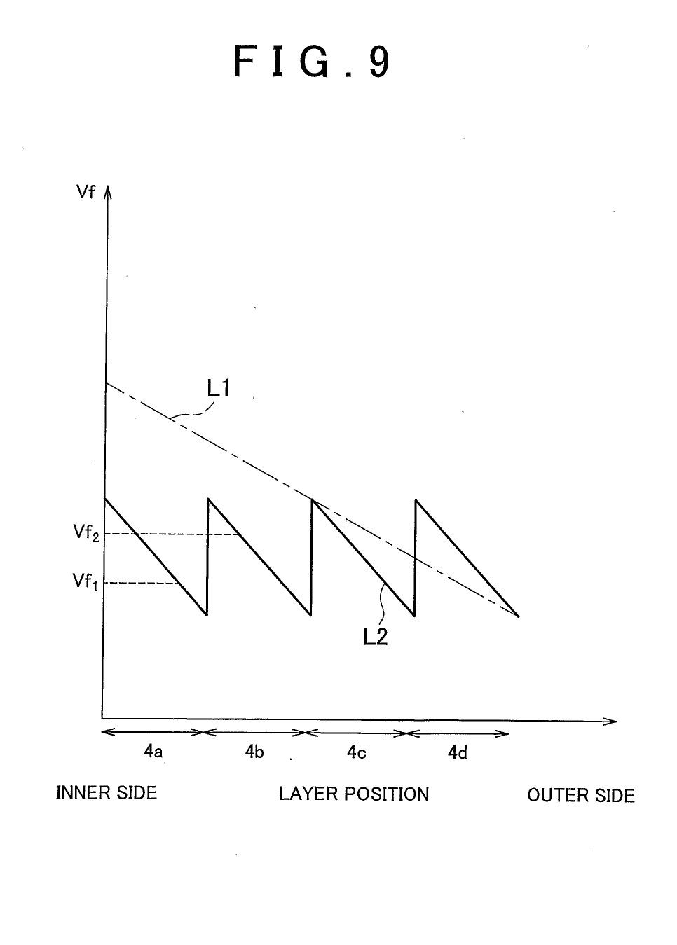

FIG. 9 is a graph indicating the fiber volume content V_{f} at each layer position in the resin-impregnated-fiber layer. In FIG. 9, the line L1 represents the fiber volume content V_{f} in the resin-impregnated-fiber layer 4 of a comparative example, and the line L2 represents the fiber volume content V_{f} in the resin-impregnated-fiber layer 4 of the first example embodiment. The forming procedures employed in the first example embodiment and the comparative example to form the resin-impregnated-fiber layer 4 are different from each other. In the first example embodiment, the foregoing forming procedure was performed by repeating the FW process four times in total (n=4 in FIG. 4).

In the forming procedure of the comparative example, on the other hand, the FW process was first performed multiple times with no gelling process and then the hardening process was performed. That is, in the comparative example, a resin-impregnated fiber was wound around the liner 3 a predetermined number of times, and then the resin in the wound portion of the resin-impregnated fiber was hardened, whereby the resin-impregnated fiber layer 4 was formed. In the resin-impregnated-fiber layer 4 thus formed, the fiber volume content V_{f} is low at the outer side and increases toward the inner side as indicated by the line L1. In other words, the ratio of the contained resin decreases toward the inner side of the resin-impregnated-fiber layer. That is, due to the tightening effect exerted by the tension applied when winding the resin-impregnated fiber, the impregnated resin seeps out of the fiber as the thickness of the resin-impregnated fiber layer 4 increases, and the amount of the seeping resin tends to be larger in the inner side of the resin-impregnated-fiber layer 4. The higher the use pressure of the high-pressure tank 1, the stronger this tendency becomes, because the thickness of the resin-impregnated-fiber layer 4 needs to be increased to increase the use pressure of the high-pressure tank 1.

In view of this, in the forming procedure of the first example embodiment, the resin 11 in the resin-impregnated fiber is gelled each time it is wound around the liner 3 before performing the next FW process. According to this method, in each FW layer, the fiber volume content V_{f} decreases toward the outer side, however, the rate of change in the fiber volume content V_{f} is almost equal among the respective FW layers. That is, in this method, because the resin 11 in the resin-impregnated fiber is gelled each time it is wound around the liner 3, the movement of the resin 11 in the resin-impregnated fiber wound around the liner 3 is suppressed. Thus, when winding the next portion of the resin-impregnated fiber around the liner 3, the seepage of the resin 11 from the already -wound portion of the resin-impregnated-fiber is suppressed. As such, the fiber volume content V_{f} varies as indicated by the zigzag line L2 in FIG. 9, and therefore the difference in the fiber volume content V_{f} between the innermost portion and the outermost portion of the resin-impregnated-fiber layer 4 is small.

Note that “a first portion having a first fiber volume content” in the invention corresponds to, for example, the outer portion of the first FW layer 4a at which the fiber volume content V_{f} is V_{f1}, and “a second portion having a second fiber volume content” in the invention corresponds to, for example, the inner portion of the second FW layer 4b at which the fiber volume content V_{f} is V_{f2}.

According to the manufacturing method of the first example embodiment, when forming the resin-impregnated-fiber layer 4, the seepage of the resin 11 due to the winding can be effectively suppressed. Further, because the next portion of the resin-impregnated fiber is wound on the already-gelled portion of the resin-impregnated fiber, for example, the possibility that a separation occurs between the mating faces of the FW layer 4a and the second FW layer 4b is very low. That is, separations at the interfaces between the respective FW layers can be prevented.

Normally, as the fiber volume content V_{f} in the resin-impregnated fiber layer is reduced, the amount of resin used to form the high-pressure tank 1 increases, and thus the outer diameter of the high-pressure tank 1 increases accordingly, and it is not desirable to use such a large high-pressure tank in the fuel cell car 100 in which the available space is very limited. According to the first example embodiment of the invention, however, because the fiber volume content V_{f} in the inner side of the resin-impregnated-fiber layer 4 can be effectively reduced, an increase in the thickness of the resin-impregnated-fiber layer 4 can be suppressed, and therefore an increase in the overall size of the high-pressure tank 1 can be suppressed effectively. In particular, in the manufacturing method of the first example embodiment, the fiber volume content V_{f} can be reduced more effectively than when the fiber volume content V_{f} is reduced by adjusting various thermal conditions, the viscosity of epoxy, and the winding tension.

As another example, the resin-impregnated fiber supplied from the supply unit 18 to the liner 3 may be a pre-preg resin-impregnated fiber.

### Second Example Embodiment

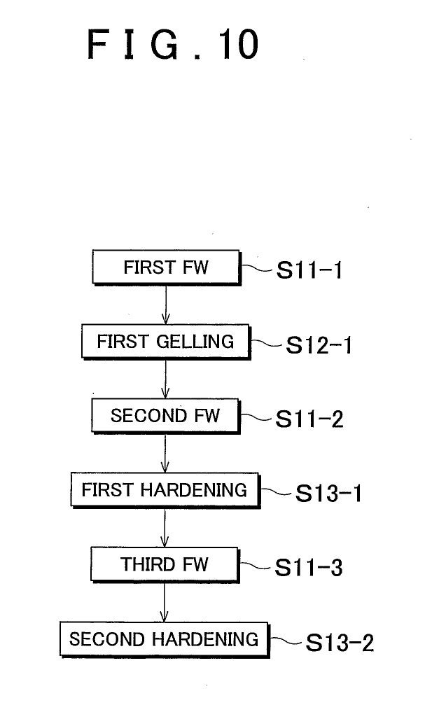

Next, a manufacturing method according to the second example embodiment of the invention will be described with reference to FIG. 10 focusing on the differences from the manufacturing method of the first example embodiment. A major difference of the manufacturing method of the second example embodiment from that of the first example embodiment lies in that the hardening process is performed in an intermediate step of the forming procedure for forming the resin-impregnated-fiber layer 4, as well as in the final step. In the second example embodiment, the contents of the FW process, the gelling process, and the hardening process are the same as those in the first example embodiment, and therefore the detail on each process is omitted herein.

In the manufacturing method of the second example embodiment, first, a predetermined amount of the resin-impregnated fiber bundle is wound around the liner 3 by performing the first FW process (S11-1), and the resin 11 of the wound resin-impregnated fiber is gelled by performing the first gelling process (S12-1), whereby the first FW layer is formed. Then, a predetermined amount of the resin-impregnated fiber bundle is wound around the gelled first FW layer by performing the second FW process (S11-2), whereby the second FW layer is formed. Then, the first hardening process is performed (13-1), whereby the resin 11 in the first FW layer and the resin 11 in the second FW layer are completely hardened. Then, the third FW process is performed (S11-3), and then the second hardening process is performed (S13-2), whereby the resin 11 in the third FW layer is completely hardened.

According to the manufacturing method of the second example embodiment, because the resin-impregnated fiber is wound on the gelled resin-impregnated fiber, the seepage of the resin 11 due to the winding is suppressed, and the possibility of layer separations in the resin-impregnated-fiber layer 4 can be minimized. In particular, even if the thickness of the FW layers have been made very large as a result of the first and second FW processes (S11-1, S11-2), the resin-impregnated-fiber layer 4 (FW layers) can be made stable by the hardening process performed midway in the forming procedure.

As another example, a manufacturing method may be employed in which the hardening process is performed one time or multiple times while repeating the FW process and the gelling process, after which the FW process and the gelling process are performed one time for each, and then the hardening process is performed as the final step.

As such, the manufacturing methods according to the invention are suitable for manufacturing pressure-resistive products, such as high-pressure tanks, high-pressure pipes, etc. In the case where high-pressure pipes are manufactured using a manufacturing method according to the invention, the wound object, which is an object around which the resin-impregnated fiber is wound, may be removed after forming the resin-impregnated fiber layer.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. (canceled)

2. The manufacturing method according to claim 18, wherein:
in the forming procedure, the winding process and the gelling process are alternately repeated multiple times.

3. The manufacturing method according to claim 18, wherein:
the gelling process is accomplished by implementing one of a room-temperature exposing method in which the wound portion of the resin-impregnated fiber is exposed to a room temperature, a constant-temperature bath heating method in which the wound portion of the resin-impregnated fiber is heated in a constant-temperature bath, and a heater heating method in which the wound portion of the resin-impregnated fiber is heated using a heater.

4. The manufacturing method according to claim 18, wherein:
the forming procedure includes a hardening process for hardening the resin in the resin-impregnated fiber.

5. The manufacturing method according to claim 4, wherein:
the hardening process is performed in a final step of the forming procedure.

6. The manufacturing method according to claim 5, wherein:
the forming procedure includes another hardening process for hardening the resin in the resin-impregnated fiber, which is performed in an intermediate step of the forming procedure.

7. The manufacturing method according to claim 4, wherein:
the resin in the resin-impregnated fiber is a thermosetting resin, and the gelling process is accomplished by heating the resin in the wound portion of the resin-impregnated fiber at a temperature lower than the temperature at which the resin in the wound portion of the resin-impregnated fiber is heated in the hardening process.

8. The manufacturing method according to claim 4, wherein:
the resin in the resin-impregnated fiber is a thermosetting resin, the gelling process is performed at a room temperature, and the hardening process is performed at a temperature higher than the room temperature.

9. The manufacturing method according to claim 18, wherein:
the resin gelled by the gelling process has a viscosity of 6000 to 12000 mPa·s.

10. The manufacturing method according to claim 18, wherein:
the resin gelled by the gelling process has a viscosity of 9000 mPa·s.

11. The manufacturing method according to claim 18, wherein:
the resin gelled by the gelling process has a hardening reaction rate of approximately 35%.

12. The manufacturing method according to claim 18, wherein
the winding process is accomplished by implementing a filament-winding method in which a fiber is impregnated with resin and a predetermined amount of the obtained resin-impregnated fiber is then wound.

13. The manufacturing method according to claim 18, wherein:
the winding process is such that a predetermined amount of the resin-impregnated fiber is wound around an wound object while rotating the wound object, and
the gelling process is such that the resin in the portion of the resin-impregnated fiber which is wound around the wound object is gelled while rotating the wound object.

14. The manufacturing method according to claim 18, wherein:
the resin in the resin-impregnated fiber is an epoxy resin.

15. (canceled)

16. (canceled)

17. (canceled)

18. A method for manufacturing a high-pressure tank that has a liner formed in a hollow shape and that has a resin-impregnated fiber layer covering the outer face of the liner, comprising:
winding a predetermined amount of a resin-impregnated fiber;
gelling the resin in the wound portion of the resin-impregnated fiber; and
hardening the resin in the wound portion of the resin-impregnated fiber, wherein:
a predetermined amount of the resin-impregnated fiber is further wound after the gelling of the resin in the wound portion of the resin-impregnated fiber.

19. A high-pressure tank comprising:
a resin-impregnated fiber layer formed by winding a resin-impregnated fiber and then hardening the wound resin-impregnated fiber, wherein:
the resin-impregnated fiber layer has a first portion having a first fiber volume content and a second portion located further to the radially outer side of the high-pressure tank than the first portion and having a second fiber volume content that is larger than the first fiber volume content.

20. The manufacturing method according to claim 18, wherein the gelling is accomplished by implementing a constant-temperature bath heating method in which the wound portion of the resin-impregnated fiber is heated in a constant-temperature bath.
